(19) United States
(12) Patent Application Publication
(10) Pub. No.: US 2005/0201914 A1
(43) Pub. Date: Sep. 15, 2005

(54) System and method for treating a flue gas stream

(75) Inventor: Douglas P. Ritzenthaler, Columbus, OH (US)

Correspondence Address: AMERICAN ELECTRIC POWER COMPANY;C/O ANTHONY J. SWANECK, 1 RIVERSIDE PLAZA, 29TH FLOOR, COLUMBUS, OH, 43215, US

(73) Assignee: American Electric Power Company, Inc., Columbus, OH (US)

(21) Appl. No.: 11/073,887

(22) Filed: Mar. 7, 2005

Related U.S. Application Data
(60) Provisional application No. 60/552,908, filed on Mar. 12, 2004.

(51) Int. Cl. B01D 53/40

(52) U.S. Cl. 423/230; 423/421; 422/171; 422/172; 422/173

(57) ABSTRACT

The present invention is a system and method for treating a flue gas stream to remove strong acid compounds selected from the group consisting of hydrofluoric acid (HF), hydrochloric acid (HCl), sulfuric acid (H₂SO₄), and sulfur trioxide (SO₃) by injecting a sodium sorbent selected from the group consisting of sodium sesquicarbonate, sodium carbonate-bicarbonate, trona ore, mechanically refined trona ore, and trona into the flue gas stream, calcining substantially all of the sodium sorbent in the presence of the flue gas stream to form a soda ash, reducing the concentration of the at least one strong acid compound in the flue gas stream by reacting the at least one strong acid compound with the soda ash to form a sodium based by-product; and changing the chemistry of the flue gas stream to reduce the overall average resistivity of the particulate matter.

The present application claims the benefit of U.S. Provisional Patent Application 60/552,908 filed Mar. 12, 2004.

### BACKGROUND OF THE INVENTION

The system and method of the present invention relates generally to a method for treating a flue gas stream to reduce the concentration of strong acid compounds in the flue gas stream while effecting a change in the volumetric and surface resistivity of particulate matter entrained in the flue gas stream, and particularly to a method for removing strong acid compounds from a flue gas stream while effecting a change in the volumetric and surface resistivity of particulate matter entrained in the flue gas stream wherein the flue gas stream is a by-product of the combustion of a carbonaceous fuel in a combustion furnace, and more particularly to a method of injecting a sodium based sorbent into a flue gas stream resulting from the combustion of a carbonaceous fuel in a combustion furnace wherein the sodium based sorbent removes sulfur compounds from the flue gas stream by reacting with them to form a sodium based by-product, and wherein the sodium based by-product acts to lower the volumetric resistivity of particulate matter entrained in the flue gas stream.

In large portions of the United States, fossil fuels, particularly coal, are used as the primary fuel source for the generation of electricity. A typical electric generating unit comprises a steam generator cycle, at least one steam turbine, and at least one electric generator. The steam generator cycle comprises a combustion furnace and one or more environmental control systems. Examples of a combustion furnace of the type contemplated herein include both supercritical and subcritical electric utility boilers. Within the combustion furnace, a carbonaceous fuel such as coal is combusted in the presence of excess levels of oxygen. Those skilled in the art will understand that coal is often referred to in descriptive terms by the amount of sulfur it contains with coal often being divided along the lines of low sulfur coal and high sulfur coal. The majority of the heat released during combustion is absorbed by water that circulates through metal tubes that form the walls of the combustion furnace. The water is converted to steam and the steam is directed to the at least one steam turbine which is generally connected through a common shaft to the at least one electric generator. Energy released from the steam rotates the turbine, which in turn, rotates the generator to create electricity.

In addition to the heat released during combustion, other by-products of combustion include bottom ash, which is collected and removed from the floor of the combustion furnace; a flue gas stream, comprising the gaseous by-products of combustion including strong acid compounds such as sulfur trioxide (“SO₃”), hydrochloric acid (“HCl”), hydrofluoric acid (“HF”); and fly ash, comprising lightweight particulate matter, a substantial portion of which becomes entrained in the flue gas stream. Those skilled in the art will understand that at flue gas stream temperatures below approximately 500 degrees Fahrenheit, SO₃ readily combines with water vapor in the flue gas stream to form sulfuric acid (“H₂SO₄”) according to the equation SO₃+H₂O→H₂SO₄, which can be present in the flue gas stream as both a vapor and an aerosol. At temperatures above 500 degrees Fahrenheit SO₃ is present in the flue gas stream in its uncombined state as SO₃ vapor. The flue gas stream is discharged from the combustion furnace through at least one flue gas duct that directs the flue gas stream to an exhaust stack where the flue gas stream is eventually discharged to the atmosphere. Before reaching the exhaust stack, the flue gas stream generally passes through at least one air heater system where heat from the flue gas stream is transferred to the combustion air entering the combustion furnace lowering the temperature of the flue gas stream from about 700 degrees Fahrenheit to about 320 degrees Fahrenheit, and through at least one environmental control system that may comprise systems for particulate control, NOx control, and SOx control.

In an effort to meet Clean Air Act regulations pertaining to NOx emissions, large consumers of fossil fuels and, in particular, electric utilities are looking to selective catalytic reduction (“SCR”) systems to control NOx emissions from their generating units. When carbonaceous fuels containing sulfur are burned, the sulfur in the fuel reacts with oxygen to form acid gases such as SO₂ and SO₃ that are entrained in the flue gas. An unintended consequence of SCR operation is an increase in levels of SO₃ in the flue gas due to the oxidation of SO₂ to SO₃ as the flue gas passes through the SCR module and comes in contact with the SCR catalyst. Elevated SO₃ concentrations can result in a prominent blue haze in the flue gas plume that is eventually discharged from the electric generating unit; therefore, although SO₃ levels are currently unregulated, there is still a desire to keep SO₃ emissions to a minimum.

Several alternative SO₃ mitigation methods are known, including lime injection into the furnace using limestone, quick lime, hydrated lime, dolomitic limestone, or dolomitic lime; magnesium hydroxide slurry injection in the furnace, dry hydrated lime sorbent injection into the flue gas stream; and sodium bisulfate solution injection upstream of the air heater. Although each of these methods is successful in reducing SO₃ concentrations in the flue gas, they each have side effects that negatively impact combustion furnace operation.

Injection of any chemical into the furnace can have a negative impact on furnace fouling and slagging by changing the ash viscosity, referred to as the T₂₅₀ temperature. T₂₅₀ temperature is defined as the temperature at which the ash achieves a viscosity of 250 poise. Some furnaces are designed for fluid ash (wet bottom units) and some are designed for solid ash (dry bottom). By changing the T₂₅₀ temperature, a fundamental design feature of the furnace can be negatively altered. This can often lead to unacceptable operating conditions, such as clinkers, or results in a need to periodically cut load for additional slag blowing. Liquid injection into the flue gas stream can result in large accumulations of ash deposits in the ducts and other negative impacts on the generating unit, such as corrosion to the duct, expansion joints, or structural members internal to the duct.

While treating the flue gas stream through the injection of sodium based compounds such as sodium carbonate, sodium bicarbonate, or trona into has been known for several years (See for example U.S. Pat. No. 4,559,211) these efforts have largely proved unsatisfactory because they (1) failed to take into account the effect that injecting a sodium based compound would have on particulate matter resistivity, and (2) focused on removing primarily SO₂ and thus proved unable to compete economically with more efficient SO₂ removal methods.

The combustion of coal also results in the production of particulate matter, known as fly ash, which must be substantially removed before the flue gas stream is discharged to the atmosphere. Mechanical, electrostatic, and hybrid methods of particulate removal are known. Mechanical methods include cyclone separators that remove particulate matter from the flue gas stream through the use of centrifugal force and bag houses, which generally involve the use of a filter medium to remove and collect the particulate matter from the flue gas stream. Precipitators utilize electrostatic methods of particulate removal and are commonly used in both large and small steam generator cycle applications. Precipitators can be broadly classified into two categories: wet and dry. A wet precipitator employs a liquid to remove collected particulate matter (PM) off of the collection surface. A dry precipitator employs mechanical means to remove PM off of the collection surface. Dry precipitators can be further classified as hot side or cold side. A hot side precipitator is located upstream of the air heater and typically operates above about 400 degrees Fahrenheit. A cold side precipitator is located downstream of the air heater and typically operates below about 400 degrees Fahrenheit. Particulate (e.g., fly ash) resistivity is critical to the operation of dry precipitators. Fly ash resistivity directly impacts the ability of the particle to receive and hold an electrical charge. An ideal range for ash resistivity is approximately 1×10⁸ to 5×10¹⁰ ohm-cm. Ash with resistivity below this range may easily lose their charge and become re-entrained. Ash with resistivity above this range do not readily accept an electrical charge, and are therefore, more difficult to capture. Wet precipitators are efficient at capturing water droplets. Therefore, particle resistivity is not as critical provided the particulate matter is wetted before capture. The water droplet along with the particulate matter is captured together. Hybrids combine both mechanical and electrostatic means to remove particulate matter from the flue gas stream.

When magnesium or calcium (lime) sorbents are injected for SO₃ removal, these elements increase fly ash resistivity and, at sufficiently high injection rates, will negatively impact the performance of the particulate collector. Power plant mass emissions are regulated and utilities commonly use plume opacity measurements to provide to regulators an indirect indication of mass emissions. Regulators typically mandate a maximum averaged opacity value. For example some states require that the opacity levels averaged over a 6-minute time period be maintained below 20%. Exceeding the state mandated 6-minute opacity limit requires that corrective measures be taken to reduce the opacity level including, if necessary, the reduction of unit load. Low SO₃ levels can also result in high flyash resistivity, independent of the presence of sorbents. The combination of low SO₃ levels due to mitigation efforts and increasing magnesium and calcium levels from the mitigation systems work together to raise fly ash resistivity, and can significantly reduce the efficiency of the particulate collector. The gradual degradation of collection efficiency during dry lime injection is especially noticeable. When flue gas opacity approaches the regulatory limit, it becomes necessary to reduce sorbent injection rate and/or reduce particulate matter loading to the particulate collector by reducing generating unit load. As a result, using either magnesium hydroxide or lime sorbent injection for SO₃ mitigation in not often practical due to the undesirable increase in fly ash resistivity.

Lowering resistivity of particulate matter through sodium addition is often employed to improve the performance of hot side precipitators, which are located on the upstream, or hot side, of the air heater. Typically this is done by injecting a sodium compound into the combustion furnace. Many times, however, increasing the sodium content in the combustion furnace has several negative side effects including increased combustion furnace slagging, fouling, and corrosion. Using sodium addition to lower particulate matter resistivity on a cold-side precipitator, that is a precipitator located on the downstream or cold-side of the air heater, is typically not employed since temperatures are low enough to use a less expensive method for loweringg particulate matter resistivity, namely SO₃ injection. In the absence of SO₃, however, sodium addition can effectively improve the collection efficiency of cold-side precipitators.

In addition to the foregoing precipitator problems, injecting calcium based sorbents, such as lime into a flue gas stream that is significantly above the water saturation temperature will lower the sorbent utilization relative to injecting the lime at or near flue gas saturation temperatures. Calcium-based sorbents generally have their highest reactivity when injected as a slurry at or near the saturation temperature of the flue gas stream. This is not the case for most sodium sorbents. Sodium sesquicarbonate, sodium carbonate-bicarbonate, trona, trona ore, and mechanically refined trona ore react best at temperatures above about 250 degrees Fahrenheit. This is consistent with an injection location upstream of the particulate collector.

What is needed is a method for removing strong acid compounds from a flue gas stream that effectively removes the strong acid compounds, eliminates the need for SO₃ injection for lowering particulate matter resistivity, and utilizes a sorbent with its highest reactivity at typical flue gas stream temperature all without degrading the collection efficiency of the particulate collection device, causing combustion furnace corrosion or increasing furnace slagging, causing an accumulation of ash deposits in the duct, or resulting in other negative impacts on steam generator cycle operation.

### SUMMARY OF THE INVENTION

The present invention is a system and method for treating a flue gas stream to remove strong acid compounds selected from the group consisting of hydrofluoric acid (“HF”), hydrochloric acid (HCl”), sulfuric acid (“H₂SO₄”), and sulfur trioxide (SO₃) through the injection of a sodium sorbent selected from the group consisting of sodium sesquicarbonate, sodium carbonate-bicarbonate, trona ore, mechanically refined trona ore, and trona into the flue gas stream, calcining substantially all of the sodium sorbent in the presence of the flue gas stream to form a soda ash, reacting the soda ash with at least one strong acid compound in the flue gas stream to form a sodium based by-product, conditioning the particulate matter in the flue gas stream with the sodium based by-product causing a decrease in the volumetric resistivity of the particulate matter, and removing the particulate matter and the remaining sodium based by-product from the flue gas stream in a particulate collector.

While the present invention is not limited in its application to flue gas streams from any one source, it is especially adapted to uses where the flue gas stream is the product of the combustion of carbonaceous fuels containing sulfur compounds, and in particular to the removal of sulfur compounds from flue gas streams resulting from the burning of coal where electrostatic methods are utilized for particulate control in which case the sodium based by-product that results from the reaction of the soda ash with the sulfur compounds in the flue gas stream interacts with the particulate matter in the flue gas stream, resulting in a decrease in the volumetric resistivity of the particulate matter which leads to more efficient removal of the particulate matter from the flue gas stream.

Sodium sesquicarbonate, sodium carbonate-bicarbonate, trona ore, mechanically refined trona ore, and trona are the preferable sorbents due to their acid scrubbing capabilities coupled with their sodium content, which is useful for improving particulate removal by maintaining optimal fly ash resistivity. On a particulate collector operating below about 400 degrees Fahrenheit, the present invention is useful for improving particulate collection by maintaining optimal fly ash resistivity even as SO₃ is removed from the flue gas. On a particulate collector operating above about 400 degrees Fahrenheit, the present invention is useful for improving particulate collection by maintaining optimal fly ash resistivity while reducing or eliminating the need for sodium addition in the furnace.

An objective of the present invention is the removal of strong acid compounds from a flue gas stream by injecting a dry sodium sorbent into the flue gas stream, calcining substantially all of the sodium sorbent in the presence of the flue gas stream to form a soda ash, and then substantially neutralizing the strong acid compounds in the flue gas stream by reacting them with the soda ash.

An additional objective of the present invention is the removal of strong acid compounds from a flue gas stream by injecting a sodium sorbent into the flue gas stream, calcining substantially all of the sodium sorbent in the presence of the flue gas stream to form a soda ash, and then substantially neutralizing the strong acid compounds in the flue gas stream by reacting them with the soda ash, wherein the sodium sorbent is selected from the group consisting of sodium sesquicarbonate, sodium carbonate-bicarbonate, trona ore, mechanically refined trona ore, and trona.

Another objective of the present invention is the removal of strong acid compounds from a flue gas stream by injecting a substantially moisture free sodium sorbent in the form of a finely divided powder into the flue gas stream, thereby avoiding agglomeration of wet particles and particle fall out in downstream flue gas ducts.

Another additional objective of the present invention is the removal of sulfur compounds from a flue gas stream by injecting a sodium sorbent into the flue gas stream, calcining substantially all of the sodium sorbent in the presence of the flue gas stream to form a soda ash, and then substantially neutralizing the strong acid compounds in the flue gas stream by reacting them with the soda ash to form a sodium based by-product.

In a steam generator cycle comprising mechanical, electrostatic, or hybrid methods of removing particulate matter from a flue gas stream, still another objective of the present invention is to remove strong acid compounds from the flue gas stream by injecting a sodium sorbent into the flue gas stream without adversely affecting the removal efficiency of the particulate collector.

In a steam generator cycle comprising an electrostatic or hybrid particulate collector to remove particulate matter from a flue gas stream, yet another objective of the present invention is to improve the particulate collection efficiency of the electrostatic or hybrid particulate collector by injecting a sodium sorbent into the flue gas stream.

In a steam generator cycle comprising an electrostatic or hybrid particulate collector to remove particulate matter from a flue gas stream, a further objective of the present invention is to remove SO₃ from the flue gas stream by injecting a sodium sorbent into the flue gas stream, while maintaining the resistivity of the particulate matter at levels conducive to particulate removal by the electrostatic or hybrid particulate collector.

In a steam generator cycle comprising an electrostatic or hybrid particulate collector to remove particulate matter from a flue gas stream, a still further objective of the present invention is to remove SO₃ from the flue gas stream by injecting a sodium sorbent into the flue gas stream, while decreasing the volumetric resistivity of the particulate matter in an effort to offset the increase in surface resistivity of the particulate matter that results from the removal of SO₃ from the flue gas stream.

In a steam generator cycle comprising an electrostatic or hybrid particulate collector to remove particulate matter from a flue gas stream, an additional objective of the present invention is to remove SO₃ from the flue gas stream by injecting a sodium sorbent into the flue gas stream, without the occurrence of a substantial increase of back corona in the electrostatic or hybrid particulate collector.

In a steam generator cycle comprising an electrostatic or hybrid particulate collector to remove particulate matter from a flue gas stream, still another objective of the present invention is to remove SO₃ from the flue gas stream by injecting a sodium sorbent into the flue gas stream, with an additional result being the reduction or minimizing of the occurrence of back corona in the electrostatic or hybrid particulate collector.

In a steam generator cycle comprising an electrostatic or hybrid particulate collector to remove particulate matter from a flue gas stream, yet another objective of the present invention is to eliminate the need for SO₃ injection to lower particulate matter resistivity, when the operating temperature of the electrostatic or hybrid particulate collector is at or below 400 degrees Fahrenheit.

In a steam generator cycle comprising an electrostatic or hybrid particulate collector to remove particulate matter from a flue gas stream, a further objective of the present invention is to reduce or eliminate the need to inject sodium compounds into a combustion furnace for the purpose of lowering the resistivity of the particulate matter, when the operating temperature of the electrostatic or hybrid particulate collection is above 400 degrees Fahrenheit.

A still further objective of the present invention is to reduce the occurrence of corrosion of the ducts and equipment of a flue gas transport system downstream of the point of sodium sorbent injection by neutralizing SO₃, HCl, HF, H₂SO₄, and other strong acids entrained in the flue gas stream.

An additional objective of the present invention is to control the rate at which a sodium sorbent is injected into a flue gas stream comprising in part SO₂ and SO₃, by limiting the quantity of the sodium sorbent injected into the flue gas stream such that substantially all of the SO₃ present is removed while substantially all of the SO₂ remains.

Another objective of the present invention is to remove SO₃ from a flue gas stream at a predetermined rate by controlling the rate at which a sodium sorbent is injected into the flue gas stream using empirical data showing the relationship between the rate of sodium sorbent injection and the rate of SO₃ removal.

Still another objective of the present invention is to remove SO₃ from a flue gas stream by controlling the rate at which a sodium sorbent is injected into the flue gas steam by monitoring the concentration of SO₃ in the flue gas stream before or after the point of sodium sorbent injection.

Yet another additional objective of the present invention is to remove SO₃ from a flue gas stream comprising SO₃ and SO₂, while limiting the removal of SO₂ by controlling the rate at which a sodium sorbent is injected into the flue gas stream by monitoring the concentration of SO₂ in the flue gas stream before and after the point of sodium sorbent injection.

A further objective of the present invention is to remove HCl, HF, and other strong acids, in addition to SO₃, from the flue gas stream while the concentration of SO₂ in the flue gas stream remains substantially unchanged.

A still further objective of the present invention is the removal of SO₃ from a flue gas stream by reacting the SO₃ with residual NaHCO₃, which is present due to incomplete calcination of the sodium sorbent.

An additional objective of the present invention is the removal of substantially all the SO₃ in the flue gas stream with no degradation in the performance of a flue gas desulfurization system.

In a steam generator cycle comprising a wet electrostatic precipitator (WESP), still another objective of the present invention is to effectuate a decrease in the specific collection area of the WESP by removing SO₃ aerosols upstream of the WESP.

In addition to the above, other features and advantages of the present invention will be apparent from the following description of the preferred embodiments thereof.

### BRIEF DESCRIPTION OF THE DRAWINGS

FIG. 1 is a schematic representation of a fossil fuel fired steam generator such as the type typically found in electric power generation applications.

FIG. 2 is a simplified schematic of a dry sodium sorbent material handling and injection system.

FIG. 3 is a graphical depiction of the percent of SO₃ reduction measured across an electrostatic precipitator as a function of dry sorbent injection in Ibm/hr/kacfm.

FIG. 4 is a graphical depiction of the percent of SO₃ reduction measured across an electrostatic precipitator as a function of moles sodium sesquicarbonate injected per mole SO₃ removed.

FIG. 5 is a graphical depiction of the secondary current of an electrostatic precipitator as a function of its secondary voltage during hydrated lime injection.

FIG. 6 is a graphical depiction of the secondary current of an electrostatic precipitator as a function of its secondary voltage during sodium sesquicarbonate injection.

### DETAILED DESCRIPTION OF THE PREFERRED EMBODIMENT(S)

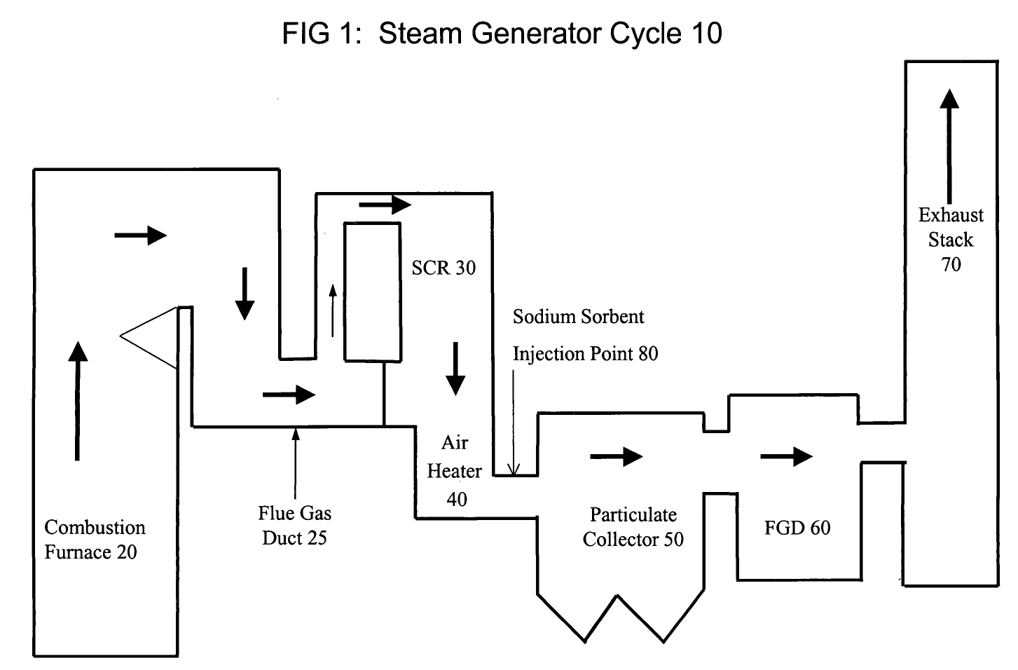

Referring now to FIG. 1, shown is a general representation 10 of a steam generator cycle of the type typically utilized in electric power generation applications. A carbonaceous fossil fuel is combusted in the presence of air in combustion furnace 20 releasing heat that is absorbed by water and steam circulating around and within the zone of combustion. In addition to the heat that is released, a flue gas stream is formed comprising water vapor, particulate matter such as fly ash, and the gaseous by-products of combustion including oxides of sulfur (SOx) and oxides of nitrogen (NOx), the levels of which must generally be reduced, in order to meet clean air standards, before the flue gas stream is discharged to the atmosphere. The flue gas stream exits combustion furnace 20 through at least one flue gas duct 25 and is directed to the inlet of selective catalytic reduction (SCR) reactor 30. The flue gas stream exits SCR reactor 30 and is directed to the inlet of air heater 40, where residual heat in the flue gas stream is used to preheat combustion air entering combustion furnace 20. After exiting air heater 40, the flue gas stream passes through at least one form of particulate collector 50, such as an electrostatic precipitator, a bag house, or a hybrid where particulate matter entrained in the flue gas stream, such as fly ash, is removed. Following particulate collector 50, the flue gas stream enters flue gas desulfurization (FGD) system 60. Upon exiting FGD system 60, the flue gas stream is discharged to the atmosphere through exhaust stack 70. An alternate arrangement is to have the SCR reactor 30 and air heater 40, located downstream of the particulate collector 50. Another alternate arrangement is to have particulate collector 50 located downstream of FGD system 60. Those skilled in the art will understand that the utilization of environmental controls such as SCR reactor 30, particulate collector 50, FGD system 60 is determined on a case-by case basis and depending on the circumstances, all or none may be used in a particular application.

When the high or low sulfur coal is utilized as the carbonaceous fuel, the majority of the sulfur present in the coal is oxidized to form gaseous SO₂ during the combustion process. A portion of the gaseous SO₂ is further oxidized to form SO₃, either during the combustion process or catalytically upon contact with iron and vanadium deposits on the interior surfaces of combustion furnace 20. The amount of SO₃ generated in combustion furnace 20 is typically 1.0% to 1.5% of the measured SO₂ at the exit of the furnace. Once the flue gas stream enters the SCR reactor 30, additional catalytic oxidation of SO₂ to SO₃ occurs when the flue gas stream contacts the vanadium-rich catalyst. The conversion rate of SO₂ to SO₃ in the SCR reactor depends on the composition of the catalyst and the SCR operating temperature, but typically ranges from 0.2% to 3.5%.

One of several factors that influence particulate collector performance, and more specifically electrostatic precipitator performance, is particulate matter resistivity. High particulate matter resistivity, generally above about 1×10¹⁰ ohm-cm, may result in decreased collection efficiencies. Particulate matter resistivity is a function of the composition and the temperature of the particulate matter. Typically, when the temperature of the particulate matter is below about 400 degrees Fahrenheit, particulate matter resistivity degrades as SO₃ is eliminated. As a result, when an electrostatic precipitator operates below about 400 degrees Fahrenheit, it is common for SO₃ to be injected into the flue gas stream upstream of the electrostatic precipitator to optimize particulate matter resistivity and thereby improve collection efficiency. Above about 400 degrees Fahrenheit, SO₃ no longer has a significant impact on particulate matter resistivity.

In the present invention, substantially moisture free sodium sorbent in the form of a finely divided powder is injected into the flue gas stream downstream of combustion furnace 20 for the dual purposes of reducing SO₃ emissions to the atmosphere and for lowering or maintaining the resistivity of the particulate matter in order to maintain or improve the collection efficiency of the particulate collector. The sodium sorbent is preferably selected from the group consisting of sodium sesquicarbonate, sodium carbonate-bicarbonate, trona ore, mechanically refined trona ore, and trona due to their acid scrubbing capabilities coupled with their sodium content. The addition of sodium to the flue gas stream is useful when an electrostatic precipitator is utilized as the particulate collector, because it assists in maintaining low fly ash resistivity even as SO₃ is removed from the flue gas stream. Injecting the sodium sorbent in the substantially moisture free form is preferred over injection of a slurry or solution due to the relative ease of handling, simplicity, safety (including lower conveying pressure), and the reduced probability of fouling occurring downstream of the injection point.

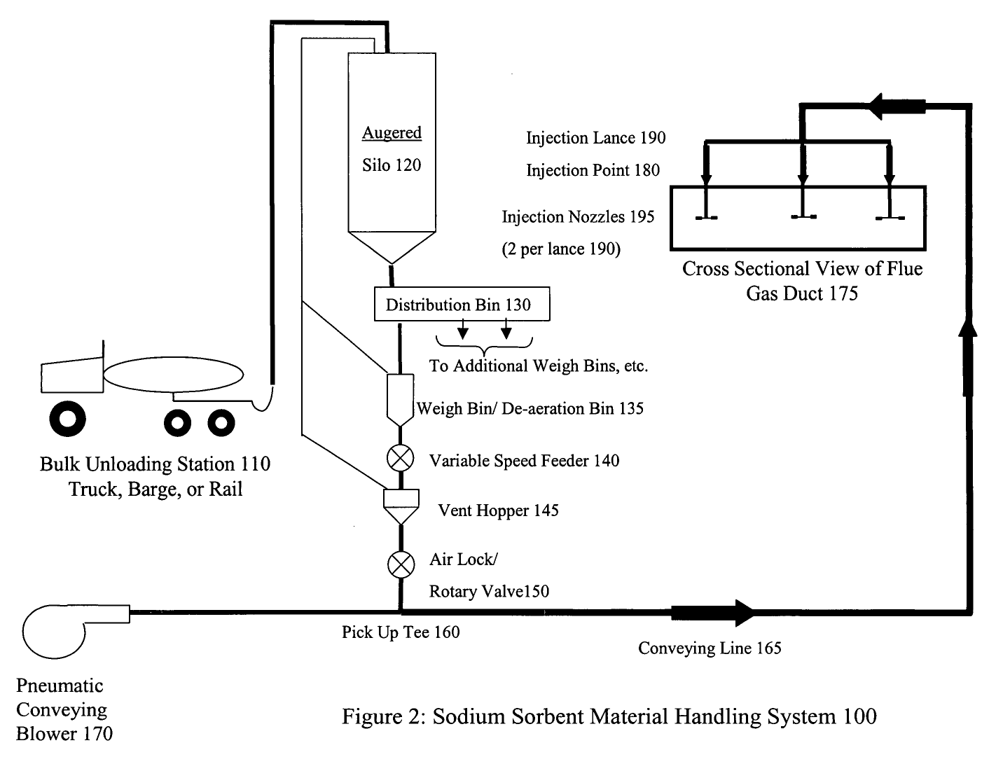

Referring to FIG. 2, shown is a simplified flow diagram 100 of a dry, or in other words, substantially moisture free sodium sorbent material handling system. The sodium sorbent is delivered to the site by truck, barge, rail, or other bulk transport methods. To avoid cross contamination with other materials, it is preferable to use dedicated containers to transport the sodium sorbent to the site. The sodium sorbent is offloaded at bulk unloading station 110 and conveyed into augered silo 120. While it is possible to replace augered silo 120 with an aerated silo, care must be taken to ensure the air supplied to the silo for aeration is essentially moisture free, or the sodium sorbent material may clump together preventing its removal from the aerated silo. The auger of augered silo 120 directs the sodium sorbent to the center of augered silo 120 where the sodium sorbent drops by gravity into weigh bin/de-aeration bin 135. The sodium sorbent is then metered out of weigh bin/de-aeration bin 135 using variable speed feeder 140 and into vent hopper 145. Preferably, vent hopper 145 and weigh bin/de-aeration bin 135 are vented to the top of augered silo 120 to prevent the feed system from becoming pressure-bound. Air lock/rotary valve 150 passes the sodium sorbent from vent hopper 145 and feeds it to pressurized pneumatic conveying line 165 at pick-up tee 160. Pneumatic conveying blower 170 provides airflow and pressure to transport the sodium sorbent from pick-up tee 160 to sodium sorbent injection lances 190, which feed the sodium sorbent to sodium sorbent injection nozzles 195. Sodium sorbent injection nozzles 195 extend through flue gas duct 175 into the flue gas stream, and are located at sodium sorbent injection point 180. The number of sodium sorbent injection lances 190 is selected by optimizing the sodium sorbent distribution in flue gas duct 175. The sodium sorbent is injected into the flue gas stream through sorbent injection nozzles 195. Typically, there is at least one sodium sorbent injection nozzle 195 for each sodium sorbent injection lance 190.

The location of sodium sorbent injection point 180 is determined by the flue gas stream velocity at each installation, the accessibility of flue gas duct 175, and the temperature of the flue gas stream. Preferably, sodium sorbent injection point 180 is located in an area of the flue gas stream with an average flue gas stream temperature of at least 250 degrees Fahrenheit, but less than 368 degrees Fahrenheit. The flue gas stream velocity should be higher than the particle transport velocity to avoid material drop out in the duct. Those skilled in the art will understand that each configuration of furnace and peripheral equipment will have its own unique geometry and flue gas stream conditions that will have to be considered in selecting the location of sodium sorbent injection point 180.

The location of the sodium sorbent injection point 180 in relation to flue gas duct 175 is also dependent upon the results desired. If lowering or maintaining the resistivity of the particulate matter to improve the efficiency of particulate matter collection, sodium sorbent injection point 180 is preferably located upstream from the particulate collector at a point that will allow sufficient time for the sodium sorbent to react with the particulate matter to achieve the desired fly ash resistivity. In applications where SCRs are installed and where the removal of SO₃ produced in the furnace and SCR reactor along with influencing the particulate matter resistivity is desired, then sodium sorbent injection point 180 is preferably located downstream of the SCR reactor and upstream of the particulate collector at a location to allow sufficient time for the sodium sorbent to react with the particulate matter to achieve the desired fly ash resistivity. If removal of SO₃ is the primary objective, then sodium sorbent injection point 180 can be located at any point in flue gas duct 175 downstream of the SO₃ sources and upstream of the FGD system, or if FGD is not utilized, then upstream of the exhaust stack. Preferably, sodium sorbent injection point 180 is located upstream of the particulate collector. If the primary objective is the reduction of strong acids to reduce corrosion, then sodium sorbent injection point 180 can be located at any point in flue gas duct 175 downstream of the acid source and upstream of the particulate collector.

Referring again to FIG. 1, when the present invention is employed on a typical fossil fuel fired steam generating cycle; SO₃ is formed primarily in combustion furnace 20 and SCR reactor 30. When particulate collector 50 is located upstream of SCR reactor 30, only the SO₃ originating from combustion furnace 20 will be effectively removed. In some cases this may be sufficient to reduce SO₃ emissions at the exhaust stack to acceptable levels.

In one embodiment of the present invention, trona was selected as the sodium sorbent. Those skilled in the art will understand that trona is a naturally occurring mineral that is chemically known as sodium sesquicarbonate. As used herein, the intent is that trona and sodium sesquicarbonate can be used interchangeably to refer to one and the same chemical compound.

A test program using trona was undertaken to verify both its effectiveness in mitigating SO₃ and its ability to lower the resistivity of the particulate matter upstream of an electrostatic precipitator. The steam generator cycle used to test the performance of trona injection was substantially configured as shown in FIG. 1. Injection of the trona occurred at sodium sorbent injection point 80 located between air heaters 40 and particulate collector 50.

The chemical formula of trona is:
Na₂CO₃•NaHCO₃•2H₂O

When trona is injected into a flue gas stream having an average temperature of at least 250 degrees Fahrenheit, the trona calcines in the presence of the flue gas stream to form soda ash according to the following chemical equation:
2[Na₂CO₃•NaHCO₃•2H₂O]+heat→3Na₂CO₃+CO₂+5H₂O

While the above equation implies a one-step calcination process, in actuality more than one step may be necessary for complete calcination to occur. One molecule of trona consists of one molecule of sodium bicarbonate, one molecule of soda ash, and two molecules of water, which are chemically bound to each other. Soda ash, sodium bicarbonate, and water are released during calcination. Sodium bicarbonate released from the trona can calcine either concurrent with or subsequent to being liberated from the trona.

Sodium bicarbonate released during calcination yields soda ash (Na₂HCO₃), along with water and carbon dioxide, as follows:
2NaHCO₃+Heat→Na₂CO₃+H₂O+CO₂

When SO₃ is present in the flue gas stream, the newly formed soda ash reacts with the SO₃ to form sodium sulfate (Na₂SO₄) and carbon dioxide as follows:
Na₂CO₃+SO₃→Na₂SO₄+CO₂

When the SO₃ in the flue gas stream combines with water vapor to form H₂SO₄ as typically occurs at temperatures of 500 degrees Fahrenheit or less, the soda ash reacts with the H₂SO₄ to form sodium sulfate (Na₂SO₄), carbon dioxide and water as follows:
Na₂CO₃+H₂SO₄→Na₂SO₄+CO₂+H₂O

In addition to SO₃, other strong acids such as hydrofluoric acid (HF) and hydrochloric acid (HCl) may be present in the flue gas stream. These acids will also react with the sodium sorbent, although generally after SO₃ or H₂SO₄ are converted to sodium sulfate.

In the case of HF the soda ash reacts with the HF in the flue gas stream to form sodium fluoride (NaF), carbon dioxide and water according to the following equation:
Na₂CO₃+2HF→2NaF+CO₂+H₂O

While in the case of HCl, the soda ash reacts with the HCl in the flue gas stream to form sodium chloride (NaCl), carbon dioxide and water according to the following equation:
Na₂CO₃+2HCl→2NaCl+CO₂+H₂O

In each case, whether the strong acid compound is HF, HCl, H₂SO₄, or SO₃, the strong acid compound reacts with the soda ash to form a sodium based by-product such as Na₂SO₄, NaF, or NaCl.

Focusing again on the case where SO₃ is present in the flue gas stream, the efficiency of the reaction with SO₃ generally increases with increased surface area of the newly formed soda ash particle. At flue gas stream temperatures above about 250 degrees Fahrenheit, the trona calcines very rapidly, releasing CO₂ and H₂O, and yielding soda ash (Na₂CO₃). The rapid emergence of gases during calcination results in decrepitation of the particle. An increase in particle surface area comes about from the generation of pores that are formed from the release of these gases as well as particle breakage. The ability to calcine the material in the flue duct allows for the trona to continue to react while gases are being liberated and exposing new particle surfaces capable of further acid neutralization.

For the removal of oxides of sulfur, the sodium sorbent particle size is important. In the present invention it is preferable that the trona be injected as finely divided particles having an average particle size equal to or less than 28 microns. Trona particles injected in the preferred size range, will calcine in the flue gas duct and provide effective SOx removal. When processing trona to the desired particle size, care must be taken to control the temperature of the trona during the milling process. If the temperature is allowed to rise above approximately 150 degrees Fahrenheit during the milling process, the trona could calcine in the mill rather than in the flue gas duct. If that occurs, it would likely result in markedly slower reaction rate in the flue gas duct and, therefore, reduce SOx removal efficiencies.

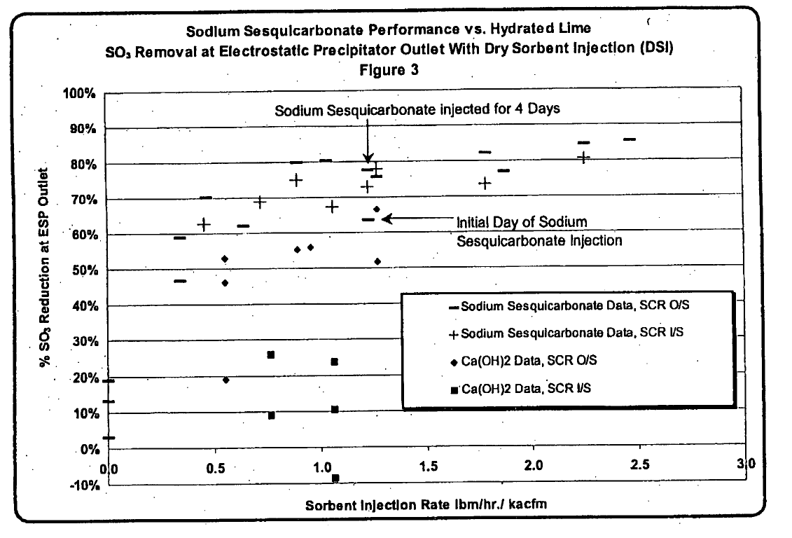

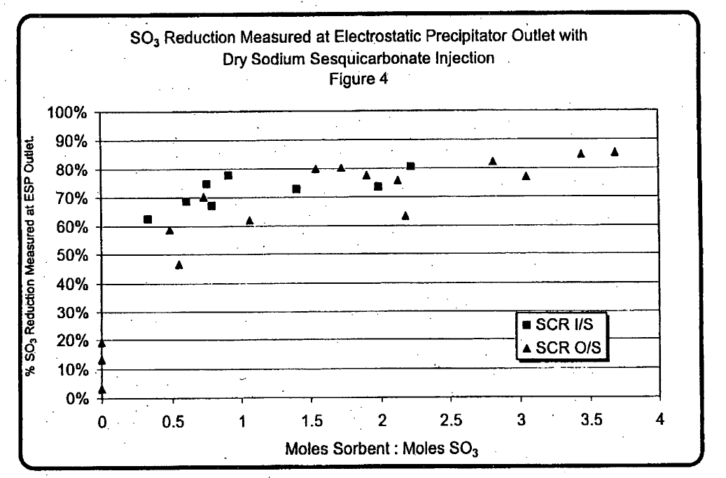

Referring now to FIG. 3 and FIG. 4, the SO₃ reduction achieved through the injection of trona is shown. Starting with FIG. 3, shown is a comparison between the SO₃ removal rates achieved using trona injection and the SO₃ removal rates achieved with hydrated lime injection. Referring also to FIG. 1, SO₃ was measured at three locations: upstream of sodium sorbent injection point 80, at the outlet of particulate collector 50, and at exhaust stack 70. The maximum injection rate for hydrated lime was limited to about 1.1 Ibm/hr/kacfm due to opacity excursions caused by the negative impact of calcium on the collection efficiency of the electrostatic precipitator. In contrast, the injection of trona did not negatively impact the performance of the electrostatic precipitator, but rather improved the particulate collection efficiency. The injection rate for trona was limited only by the maximum speed of variable speed feeder 140. Testing demonstrated that SO₃ removal efficiencies increased after the first day of trona injection. This is likely due to unreacted trona accumulating over time on the precipitator collector plates, and then reacting with residual SO₃ still in the flue gas stream. FIG. 4 illustrates the SO₃ removal rates as a function of the moles of sodium sesquicarbonate injected versus the percent reduction of SO₃ measured at the outlet of an electrostatic precipitator. Note that there is not a significant increase in removal rates above about 1 to 1.5 moles sodium sesquicarbonate per mole SO₃.

The optimum injection rate is determined by the target SO₃ emission rate desired. Table 1 shows expected SO₃ removal rates at the ESP outlet. Additional SO₃ reductions may be seen across the FGD system and the air heater if they are located down stream of the particulate collector.

TABLE 1
% SO₃ Removal at Various Trona
Injection Rates with SCR In Service

| | % SO₃ Removal |
|---|---|
| Trona Injection Rate | Measured at Exit of |
| Lb/hr/kacfm | Precipitator |
| 0 | 15 |
| 0.5 | 63 |
| 1.0 | 71 |
| 1.5 | 76 |
| 2.0 | 78 |

Although the equations imply that all of the trona calcines into soda ash and that all the soda ash reacts with SO₃ to form the reactant Na₂SO₄, the actual chemical kinetics are much more complicated. Plant operating experience while employing this technology has demonstrated that another reactant is present. Evidence of sodium bisulfite (NaHSO₄) has been discovered. The amount of NaHSO₄ formed is very small, however, if it is present in the liquid phase, it can initiate deposition on internal duct structures such as turning vanes, structural support members, and flow distribution screens such as perforated plates commonly used at the inlet of ESP's. Plugging of the flow distribution screens is especially problematic.

Modeling of the chemical kinetics provided results that are consistent with observations of ash agglomeration and deposition in the flue gas duct. Ash agglomeration and deposits in the flue gas duct were observed after operating for several months. These deposits were limited to structures that were perpendicular to gas flow. For example, a steel angle in the flue gas duct would have deposits only on the side that faced into the flue gas stream flow. No deposits were found on the sides or back of the member. An additional observation was that the deposits only appeared in the hotter portions of the flue gas duct. The flue gas stream temperature is stratified downstream of the air heater. Cooler portions of the flue gas duct were completely clear of any accumulations of ash. Members within the hotter portions of the flue gas duct had ash accumulations that formed and became hard. The ceiling and sides of the flue gas duct itself remained clear. The flue gas duct floor only had ash accumulation from debris falling off of internal members. Cleaning of the flue gas duct was relatively quick and easy when employing high-pressure water sprays. Since the sodium bisulfite is water-soluble, the agglomerations easily broke apart and were directed down a flue gas duct drain and into a vacuum truck.

Kinetic modeling was employed to confirm that liquid sodium bisulfite could exist at higher flue gas duct temperatures. Modeling results indicated that liquid sodium bisulfate can exist in a typical flue gas stream between 368 degrees Fahrenheit (the “critical temperature”) and 413 degrees Fahrenheit. This suggests that by avoiding this temperature range, the ash accumulation problem would be avoided—a conclusion supported by direct observation and experience.

Ash build up was found to be both manageable and, based on both the kinetics modeling and experience, ultimately avoidable. Experience shows that build up on the leading surface of the ESP flow distribution screens (perforated plates) were readily removed with impact force. This suggests that the addition of rapping would maintain the flow distribution screens in a clean state. The use of cleaning mechanisms for the turning vanes may be more challenging, but vane rappers are commercially available. Injection downstream of turning vanes and other internal members would be preferable although this is not necessary when injecting into flue gas stream below the critical temperature indicated above.

Flue gas stream temperatures can be maintained below the critical 368 degrees Fahrenheit temperature by lowering air heater outlet set point temperature, gas cooling (e.g., introduction of quench air or water evaporation), or by gas mixing. The latter became an option when it was discovered that despite hot spots in the flue gas duct, the bulk flue gas stream temperature was below 368 degrees Fahrenheit. A passive mixing device installed in the flue gas duct would lower the peak flue gas stream temperatures below 368 degrees Fahrenheit. All of these option can be used to maintain peak flue gas stream temperatures below the critical temperature and thereby avoid the ash deposition and agglomerations altogether.

Flue gas scrubber performance during the injection of trona was also monitored. No discernable impact on FGD system performance was noticed. Since the precipitators will collect the particulate matter produced by the SO₃ neutralization reaction prior to the flue gas stream entering the FGD system, no flue gas scrubber chemistry upsets were predicted, nor were any observed.

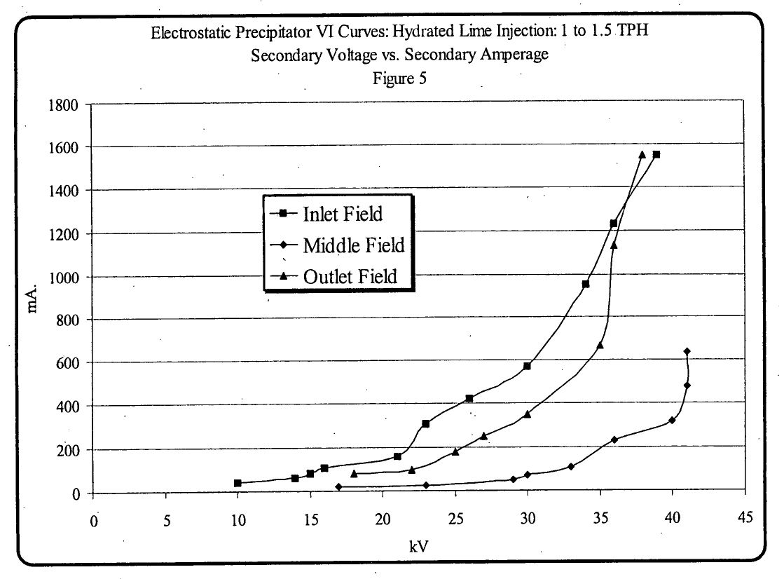

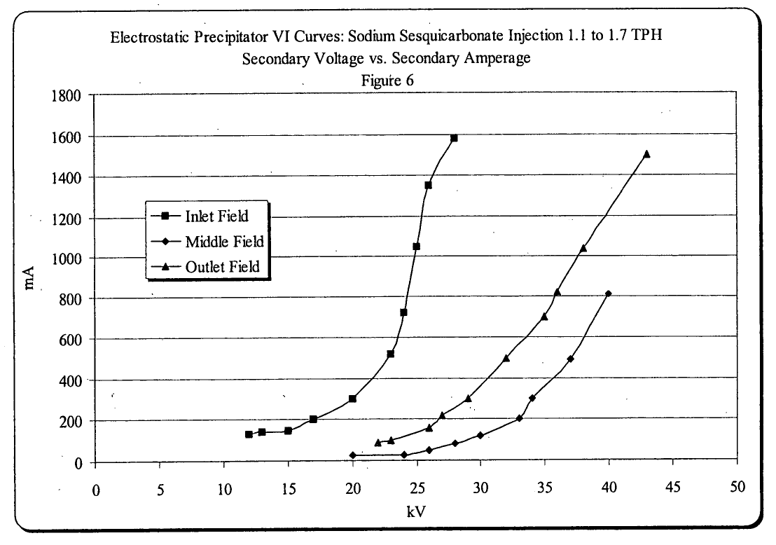

Determining the effect of injecting trona on the performance of the electrostatic precipitator was another objective of the test program. There was a concern that the addition of trona would negatively impact electrostatic precipitator performance since it raised the concentration of particulate matter in the flue gas stream, and because of the negative impact experienced with lime (calcium) injection. FIG. 5 and FIG. 6 compare secondary voltage/current (VI) data from the electrostatic precipitator for hydrated lime and trona injection, respectively. VI curves are essential in understanding the performance of the ESP. Back corona is indicative of high resistivity particulate matter, that is, particulate matter that is difficult to capture. Back corona is identified on a VI curve when an increase in current results in a decrease in voltage. The onset of back corona is evident in FIG. 5 on the middle field. Referring to FIG. 6, there are no indications of back corona while trona was injected. Back corona was not detected even after the injection rates were nearly doubled. The lack of back corona indicates that although SO₃ levels drop significantly with high sorbent injection rates, the particulate matter resistivity was not excessive, and; therefore, the collection efficiency of the particulate collector did not degrade. In fact, trona has been demonstrated to be useful in improving collection efficiency absent the need for strong acid compound mitigation.

Electrostatic precipitator current density was observed to be higher with trona injection as compared to hydrated lime or magnesium hydroxide injection. Current density is the power per unit area going to the wires and plates of the electrostatic precipitator. This is the power that charges the particles for collection. Typically, an increase in power density corresponds to an increase in particulate matter collection efficiency. However, in the presence of back corona, increased power levels do not necessarily correspond to an increase in particulate matter collection efficiency. This is why it is important to operate without back corona.

Electrostatic precipitator current density during trona injection is comparable to or higher than levels recorded without the injection of SO₃ mitigation sorbents into the flue gas stream. This increase in power indicates better particulate matter collection efficiency since (in the absence of back corona) an increase in power typically indicates higher collection efficiency. So encouraging were the results that the test unit now employs trona injection to reduce opacity excursions even during times when SO₃ mitigation is unnecessary.

In recent years numerous vendors have suggested the use of wet electrostatic precipitators (WESP's) to remove SO₃ aerosols from the flue gas stream. However, there is a large capital expense associated with the installation of such equipment, whether as a retrofit to an existing site, or in a new facility. Although WESP's have historically been employed to capture particulate matter, including SO₃ aerosols, there are limitations to the capture efficiency. In addition, experience employing WESP's for removing SO₃ aerosols contained in a flue gas stream with a high water droplet loading is limited, and, therefore, presents a risk to the end user as to whether the design capture of SO₃ aerosols will be attained. Typically, an increase in capture efficiency is accomplished by increasing the specific collection area (SCA) of the WESP. That is, the total surface area of the collection plates must increase. This typically requires larger, if not additional collection fields, thereby substantially increasing capital costs. By injecting trona upstream of the WESP, capital costs can be minimized by increasing the SO₃ capture rate, while minimizing the SCA.

In summary, testing using trona injection showed significantly reduced SO₃ levels. Electrostatic precipitator data taken during trona injection indicates that the trona injection does improve electrostatic precipitator performance. In addition, no discernable degradation of FGD system performance was observed.

As the test results indicate, sodium sorbent injection is useful in reducing strong acid compound concentrations in a flue gas stream, and in creating sodium based by-products. The sodium based by-product created by the reaction between the soda ash and the strong acid compounds in the flue gas stream, whether that is Na₂SO₄ in the presence of SO₃, NaF in the presence of HF, or NaCl in the presence of HCl, has the added benefit of acting to change the chemistry of the flue gas stream downstream of the sodium sorbent injection by decreasing the volumetric resistivity of the particulate matter, thereby offsetting increases in the surface resistivity of the particulate matter that occurs when SO₃ is removed from the flue gas stream. As those skilled in the art will understand, particulate matter resistivity is comprised of surface and volumetric resistivity. SO₃ adsorbs onto the surface of the particulate matter with water and impacts the surface resistivity. Volumetric resistivity is determined by the elemental make up of the particulate matter. Sodium acts to lower the volumetric resistivity of the particulate matter. Therefore, it is possible to offset adverse changes in one form of resistivity with positive changes in the other form. An essentially simultaneous change in particulate matter resistivity takes place when the sodium sorbent is injected into the flue gas stream. The surface resistivity of the particulate matter increases due to the removal of SO₃ from the flue gas stream as a result of the sodium sorbent calcining into soda ash, and the soda ash reacting with the SO₃ to form sodium sulfate. At essentially the same time, there is a decrease in the volumetric resistivity of the particulate matter due to an increase in the sodium content of the particulate matter, which, in turn, facilitates the ability of the particulate matter to carry an electrical charge. Those skilled in the art will understand that while the changes in surface resistivity and volumetric resistivity may happen one after the other, the changes occur so quickly that they essentially occur simultaneously.

Several methods are available to provide information for determining the optimum rate of sodium sorbent injection. Sodium sorbents, like most alkali reagents, tend to react more rapidly with the stronger acids, and then,

1. A method for treating a flue gas steam, the method comprising the steps of:
combusting a carbonaceous fuel in a combustion furnace to form a flue gas stream, wherein the flue gas stream comprises water vapor, particulate matter, and at least one strong acid compound;
injecting a sodium sorbent into the flue gas stream downstream of the combustion furnace;
calcining substantially all of the sodium sorbent in the presence of the flue gas stream to form a soda ash;
reducing the concentration of the at least one strong acid compound in the flue gas stream by reacting the at least one strong acid compound with the soda ash to form a sodium based by-product; and
changing the chemistry of the flue gas stream to reduce the overall average particulate matter resistivity.

2. The method of claim 1 wherein the sodium sorbent is selected from the group consisting of sodium sesquicarbonate, sodium carbonate-bicarbonate, trona ore, mechanically refined trona ore, and trona.

3. The method of claim 1 wherein the at least one strong acid is selected from the group comprising HF, HCl, H₂SO₄ and SO₃.

4. The method of claim 1 wherein the step of changing the resistivity of the particulate matter further comprises the steps of increasing the surface resistivity of the particulate matter and decreasing the volumetric resistivity of the particulate matter.

5. The method of claim 1 wherein the flue gas stream further comprises SO₂ and SO₃.

6. The method of claim 5 wherein at flue gas stream temperatures below approximately 500 degrees Fahrenheit the SO₃ combines with the water vapor to form H₂SO₄.

7. The method of claim 5 wherein the at least one strong acid compound is SO₃ and at least one addition compound selected from the selected from the group consisting of HF and HCl.

8. The method of claim 6 wherein the at least one strong acid compound is H₂SO₄ and at least one addition compound selected from the group consisting of HF and HCl.

9. The method of claim 1 wherein the carbonaceous fuel is coal.

10. The method of claim 9 wherein the coal is high sulfur coal.

11. The method of claim 5 wherein the rate at which the sodium sorbent is injected into the flue gas stream is selected such that the sodium sorbent reacts with substantially all of the SO₃ in the flue gas stream while the concentration of SO₂ in the flue gas stream remains substantially unchanged.

12. The method of claim 5 wherein the rate at which the sodium sorbent is injected into the flue gas stream is selected by monitoring the concentration of the SO₂ in the flue gas stream both upstream or downstream of the sodium sorbent injection point.

13. The method of claim 11 wherein the concentration of the SO₃ in the flue gas stream is determined through batch sample collection and analysis.

14. The method of claim 11 wherein the concentration of the SO₃ in the flue gas stream is determined in real-time.

15. The method of claim 11 wherein the concentration of the SO₃ in the flue gas stream is determined in near real-time.

16. The method of claim 1 wherein the sodium sorbent is essentially a moisture free finely divided powder having an average particle size equal to or less than 28 microns.

17. The method of claim 1 wherein the average temperature of the flue gas stream at the location of sodium sorbent injection is at least 250 degree Fahrenheit but less that 368 degrees Fahrenheit.

18. The method of claim 1 wherein the particulate matter is fly ash.

19. The method of claim 1 wherein the particulate collector is a mechanical particulate collector.

20. The method of claim 1 wherein the particulate collector is a hybrid particulate collector.

21. The method of claim 1 wherein the particulate collector is an electrostatic precipitator.

22. The method of claim 20 wherein the average operating temperature of the electrostatic precipitator is less than or equal to 400 degrees Fahrenheit.

23. The method of claim 20 wherein the average operating temperature of the electrostatic particulate collector is greater than 400 degrees Fahrenheit.

24. The method of claim 20 wherein the injection of the sodium sorbent into the flue gas stream results in a reduction in the occurrence of back corona in the electrostatic precipitator.

25. The method of claim 5 wherein the particulate collector is a wet electrostatic precipitator.

26. The method of claim 24 wherein the specific collection area of the wet electrostatic precipitator is proportional to the capture rate of SO₃ upstream of the wet electrostatic precipitator.

27. The method of claim 1 wherein the step of changing the chemistry of the flue gas stream to reduce the overall average particulate matter resistivity further comprises the steps of increasing the average surface resistivity of the particulate matter downstream of the sodium sorbent injection; and decreasing the average volumetric resistivity of the particulate matter downstream of the sodium sorbent injection.

28. The method of claim 1 further comprising the step of removing substantially all of the particulate matter and the sodium based by-product from the flue gas stream in a particulate collector, wherein the particulate collector is selected from the group consisting of mechanical particulate collectors, electrostatic particulate collectors, and hybrid particulate collectors

29. A method for treating a flue gas steam, the method comprising the steps of:
combusting a carbonaceous fuel in a combustion furnace to form a flue gas stream, wherein the temperature of the flue gas stream is at least 250 degree Fahrenheit but less than 368 degrees Fahrenheit and wherein the flue gas stream comprises water vapor, particulate matter, and at least one strong acid compound selected from the group consisting of HF, HCl, H₂SO₄, SO₃;
injecting a sodium sorbent into the flue gas stream downstream of the combustion furnace and upstream of a particulate collector wherein the sodium sorbent is selected from the group consisting of sodium sesquicarbonate, sodium carbonate-bicarbonate, trona ore, mechanically refined trona ore, and trona and wherein the sodium sorbent is an essentially moisture free finely divided powder having an average particle size equal to or less than 28 microns;
calcining substantially all of the sodium sorbent in the presence of the flue gas stream to form a soda ash;
reducing the concentration of the at least one strong acid compound in the flue gas stream by reacting the at least one strong acid compound with the soda ash to form a sodium based by-product;
increasing the surface resistivity of the particulate matter downstream of the sodium sorbent injection;
decreasing the volumetric resistivity of the particulate matter downstream of the sodium sorbent injection; and
removing substantially all of the particulate matter and the sodium based by-product from the flue gas stream in a particulate collector, wherein the particulate collector is selected from the group consisting of mechanical particulate collectors, electrostatic particulate collectors, and hybrid particulate collectors.

30. A system for removing strong acid compounds from a flue gas stream of a steam generator cycle, the system comprising:
a combustion furnace wherein a carbonaceous fuel is combusted in the presence of oxygen to form a flue gas stream, the flue gas stream comprising particulate matter, water vapor, and at least one strong acid compound wherein the at least one strong acid compound is selected from the group consisting of SO₃, HCl, and HF;
at least one flue gas duct in mechanical communication with the combustion furnace through which the flue gas stream traverses, the flue gas duct having an inner and an outer surface wherein the flue gas stream is in fluid contact with the inner surface of the flue gas duct;
at least one sodium sorbent injection probe having at least one terminal end, wherein the at least one terminal end passes through the outer and the inner surface of the at least one flue gas duct so as to be in fluid contact with the flue gas stream;
at least one sodium sorbent delivery system in mechanical communication with the at least one sodium sorbent injection probe;
at least one source of sodium sorbent assessable to the at least one sodium sorbent delivery system wherein the sodium sorbent is selected from the group consisting of sodium sesquicarbonate, sodium carbonate-bicarbonate, trona ore, mechanically refined trona ore, and trona; and
at least one particulate collection system through which essentially all the flue gas stream passes, the particulate collection system being in mechanical communication with the at least one flue gas duct and positioned downstream of the at least one sorbent injection probe.
